(19) United States
(12) Patent Application Publication
(10) Pub. No.: US 2023/0167005 A1
(43) Pub. Date: Jun. 1, 2023

(54) IS Machine for Producing Glass Containers and Method for Operating an IS Machine of This Kind

(71) Applicant: Heye International GmbH, Obernkirchen (DE)

(72) Inventors: Matthias Lunacek, Obernkirchen (DE); Mirko Wallbaum, Obernkirchen (DE); Maximilian Stäblein, Minden (DE); Benedikt Felgenhauer, Herford (DE)

(21) Appl. No.: 18/071,174

(22) Filed: Nov. 29, 2022

(30) Foreign Application Priority Data
Nov. 30, 2021 (DE) 10 2021 131 486.0

(51) Int. Cl. C03B 40/027; C03B 9/18; C03B 9/16

(52) U.S. Cl. CPC C03B 40/027; C03B 9/18; C03B 9/165

(57) ABSTRACT

An IS machine for producing glass containers includes a plurality of stations which each comprise a blank mold and a finishing mold, and comprising a lubricating tool for lubricating at least some of the blank molds with a lubricant, the lubricating tool comprising a spray head for spraying the lubricant and comprising a robot connection, to which the spray head is fastened and by means of which the spray head is movable between different stations within the IS machine, wherein the spray head is reversibly detachably fastened to the robot connection by means of a coupling. This provides the option of protecting a robot manipulating the lubricating tool without high repair costs being incurred in the event of a collision.

The invention relates to an IS machine for producing glass containers, comprising a plurality of stations which each comprise a blank mold and a finishing mold, and comprising a lubricating tool for lubricating at least some of the blank molds with a lubricant, the lubricating tool comprising a spray head for spraying the lubricant and comprising a robot connection, to which the spray head is fastened and by means of which the spray head is movable between different stations within the IS machine. The invention also relates to a method for operating an IS machine of this kind.

IS machines for producing glass containers are well known from the prior art and are typically operated in a blow-blow process. In this process, glass is liquefied in a melting end and flows out of the melting end into a feeder. An elongate glass gob is formed at the head of the feeder by means of a riser machine. This glass gob is conducted into a blank mold through a pivoted funnel mechanism via a channel. The subsequent neck of the glass container to be produced points downward in this case. A blank mold base is then placed onto the funnel mechanism and closes the blank mold. Compressed air is blown in from the top, such that the glass mass provided by the glass gob completely fills a neck mold fitted to the bottom of the blank mold. This step is called blowing down. The blank mold base and then the funnel mechanism then pivot back and the blank mold is closed at the top by the blank mold base. The glass is pre-blown into the opening thus formed at the bottom by compressed air flowing in to form the parison. The blank mold is then opened and the pre-blown workpiece, i.e. the parison, is pivoted by 180° into the associated open finishing mold by a transfer mechanism. In this process, the parison is held in a neck mold. The neck is then at the top. The neck mold is then opened and the transfer mechanism pivots back into the starting position in order to receive the next parison in the blank mold. Meanwhile, the finishing mold is closed from the top by a blowing head in order to finish-blow the parison in the finishing mold by means of compressed air into its final form. The blowing head then pivots back, the finishing mold is opened, and a gripper conveys the finished workpiece to a deadplate. In general, another mechanism then pushes the finished workpiece onto a belt, which conveys the article into a cooling region.

In terms of providing uniform product quality that is constant over time, the surfaces of the blank mold that come into direct contact with the molten glass require lubrication in order to ensure uniform distribution of the glass material within the mold cavity when said glass material is introduced into the blank mold and to make it easier to release the parison, which is still mechanically unstable, from the blank mold after shaping. For this purpose, it is known from EP 3 190 093 A1, for example, to use a lubricating tool for lubricating at least one of the blank molds with a lubricant, e.g. in the form of a lubricating robot. In principle, a lubricating robot of this kind can be used to lubricate all the blank molds. However, it is also possible for a lubricating robot of this kind to only lubricate some of the blank molds, meaning that at least one further lubricating robot is provided for the other blank molds of the IS machine.

It is also known from practice that the lubricating tool comprises a spray head, arranged on a spray head holder, for spraying the lubricant and comprises a robot connection, to which the spray head holder is fastened and by means of which the lubricating tool can be attached to a robot, such that the spray head is movable between different stations within the IS machine by means of the robot. The lubricating tool can certainly also comprise a plurality of spray heads, which are arranged on the spray head holder. In this case, the spray head holder can be provided with predetermined breaking points at which the spray head holder breaks apart in the event of a collision with the mechanisms of the station at which the lubricating tool is currently located. In this way, the flow of force is interrupted, meaning that the robot cannot sustain any damage.

In the event of a collision, the spray head holder is therefore mechanically destroyed, which requires the spray head holder to be changed and potentially also requires the spray head holder together with its spray head to be replaced, and this therefore means downtime for the corresponding station or even for the entire IS machine. This incurs costs for replacing the spray head holder and potentially also the spray head as well as for the corresponding assembly time.

US 2011/0296874 A1 discloses a method for producing a hollow glass product by means of an IS machine and a robot that is movable along its blank mold side, the robot being suitable for replacing one or more blank molds, section by section, and carrying an electromagnet, and replacing a blank mold involves closing the two half-shells of the blank mold by exerting pressure, operating the electromagnet, reducing the pressure, and then releasing the blank mold. In addition, the robot is suitable for carrying a plurality of tools having different functions.

Proceeding from this, the problem addressed by the invention is to provide an option for protecting the robot used for manipulating the lubricating tool without there being a long assembly time in the event of a collision between the spray head and an apparatus of the IS machine.

This problem is solved by the subject matter of the independent claims. Preferred developments are found in the dependent claims.

According to the invention, an IS machine is thus provided for producing glass containers, comprising a plurality of stations which each comprise a blank mold and a finishing mold, and comprising a lubricating tool for lubricating at least some of the blank molds with a lubricant, the lubricating tool comprising a spray head for spraying the lubricant and comprising a robot connection, to which the spray head is fastened and by means of which the spray head is movable between different stations within the IS machine, characterized in that the spray head is reversibly detachably fastened to the robot connection by means of a coupling.

A key point of the invention is thus that predetermined breaking points are no longer provided to prevent damage to the robot in the event of a collision. Instead, the invention provides a coupling between the spray head and the robot connection, which coupling opens in the event of a collision such that the spray head is separated from the robot connection and therefore no more force can be transmitted to the robot connection and thus to the robot. This coupling is designed such that the spray head is reversibly detachable from the robot connection, which means that the spray head can be fastened to the robot connection again via the coupling, i.e. by closing the coupling. The coupling can therefore be reversibly closed and opened, which means that the coupling does not sustain any damage when it is opened, and therefore it can be closed again without being repaired.

It is possible that the spray head is fastened directly to the robot connection by means of the coupling. Preferably, the spray head is, however, arranged on a spray head holder, and the spray head holder is fastened to the robot connection by means of the coupling. In this case, the spray head is therefore fastened indirectly to the robot connection, namely via the spray head holder.

In principle, different couplings can be used for the invention, by means of which the spray head is reversibly detachably fastened to the robot connection. According to a preferred embodiment of the invention, the coupling is a magnetic coupling. The strength of the magnet used for a magnetic coupling of this kind can be used to set the force that needs to be applied to the spray head to separate it from the robot connection.

According to an alternative preferred development of the invention, it is provided that the coupling is a safety coupling comprising a mechanism which reversibly detaches the spray head from the robot connection when a force exceeding a predetermined force value is applied to the spray head. A safety coupling of this kind can be constructed in accordance with the ball-catch principle, for example. In this case, the spray head is connected to the robot connection in a form-fitting manner by means of balls or rollers. The coupling hub is designed as a ball cage and is used as a receptacle for a flange ring, an index plate comprising a disc spring, and an adjusting nut. The balls or rollers are pressed into countersunk holes in the flange ring at a set spring force. In the event of excessive loading, the flange ring rotates relative to the cage hub, the balls are pushed out of the spherical indentations, and the spray head is separated from the robot connection.

According to the invention, it is provided that the robot connection is provided with a sensor, by means of which it can be detected whether the coupling is open or closed. In this case, the sensor is connected to a switch apparatus, using which the operation of the station can be terminated or a robot action can be initiated so that the robot e.g. retracts from the station when it is established by the sensor that the coupling is open. In this way, damage to the spray head and the robot in the station, which otherwise continues to operate, can be counteracted. This configuration also makes it possible for the spray head to be manually fastened to the robot connection again by a person, for example, such that this station can then continue to be operated. In this respect and in this context, it is preferable that the switch apparatus is designed and configured such that the operation of the station at which the spray head is currently located is permitted again when it is established by the sensor that the coupling is closed again. In this case, however, the station and/or the robot is preferably not put back into operation automatically, but only after this is approved by a user.

The supply of lubricant and atomizing air is generally required for operating the spray head. Furthermore, the spray function of the spray head can be controlled by an air supply, meaning that it also requires control air to be supplied. In this aspect, according to a preferred development of the invention, it is provided that a spray head holder supporting the spray head is provided with a control air line, a lubricant line, and/or an atomizing air line, and at least one of these lines extends at least partly in the interior of a spray head holder to which the spray head is fastened. By integrating a line of this kind in the interior of the spray head holder, in most portions of the spray head holder hose lines are no longer required on the outside, which therefore are not exposed to high temperatures prevailing in the surroundings of an IS machine. Premature aging of these kinds of hose lines, which are typically made of non-temperature-resistant plastics material, due to temperature effects is therefore no longer a concern. Furthermore, in the event of a collision, hose lines of this kind can tear or hose connectors can break, possibly resulting in compressed air or lubricant leaking out in an uncontrolled manner. In addition, according to a preferred development of the invention, it is provided that all the lines extend completely in the interior of the spray head holder and are each provided with a connection adjacently to the coupling, and a hose is attached to each of the connections and is connected to the robot connection at its other end in order to supply the spray head with control air, lubricant, or atomizing air.

The invention also relates to a method for operating an IS machine for producing glass containers, wherein the IS machine comprises a plurality of stations which each comprise a blank mold and a finishing mold, and comprises a lubricating tool for lubricating at least some of the blank molds with a lubricant, the lubricating tool comprising a spray head for spraying the lubricant and comprising a robot connection, to which the spray head is reversibly detachably fastened by means of a coupling, comprising the following method steps:
moving the spray head between different stations within the IS machine and lubricating a relevant blank mold,
detecting whether the coupling is closed or open, and
terminating the operation of the station at which the spray head is currently located and/or initiating a robot action when it is established that the coupling is open.

Preferred configurations of the method according to the invention arise by analogy with the above-described preferred developments of the IS machine according to the invention.

In the following, the invention will be explained in greater detail on the basis of a preferred exemplary embodiment with reference to the drawings, in which:

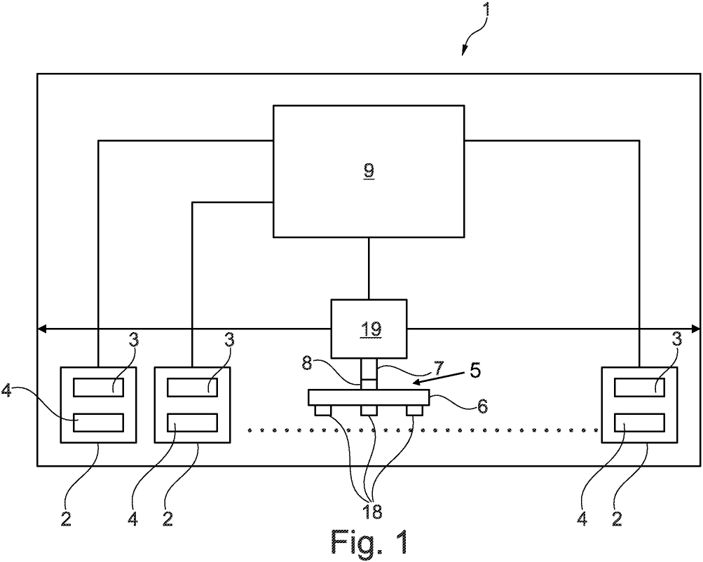

FIG. 1 schematically shows an IS machine according to a preferred exemplary embodiment of the invention,

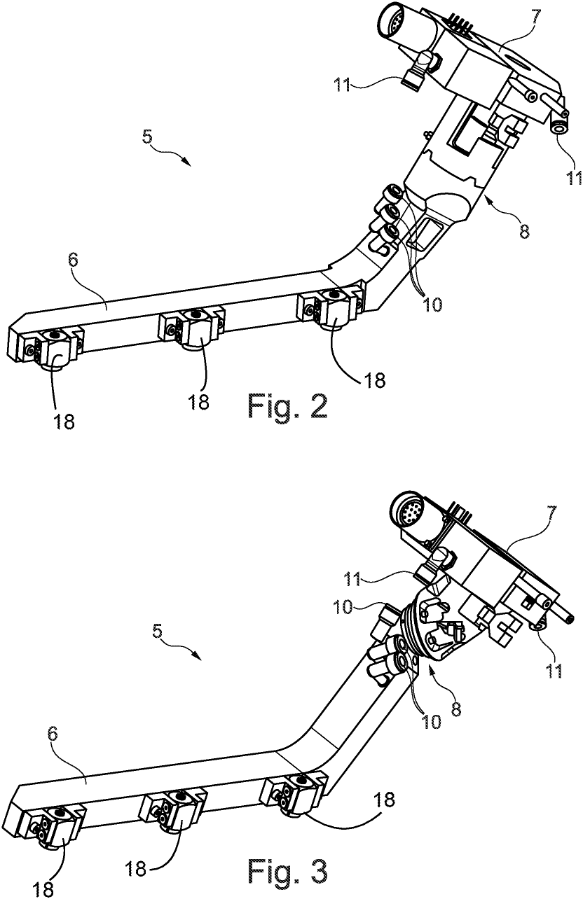

FIG. 2 schematically shows a lubricating tool according to a preferred exemplary embodiment of the invention in which the coupling is a magnetic coupling,

FIG. 3 schematically shows a lubricating tool according to a preferred exemplary embodiment of the invention in which the coupling is a safety coupling,

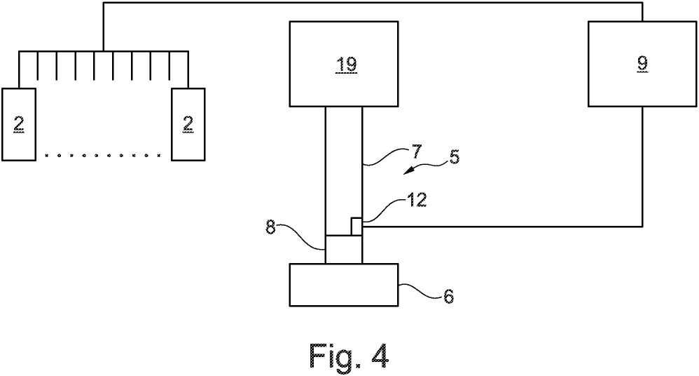

FIG. 4 is a schematic, enlarged view, inter alia, of the lubricating tool from FIG. 1, and

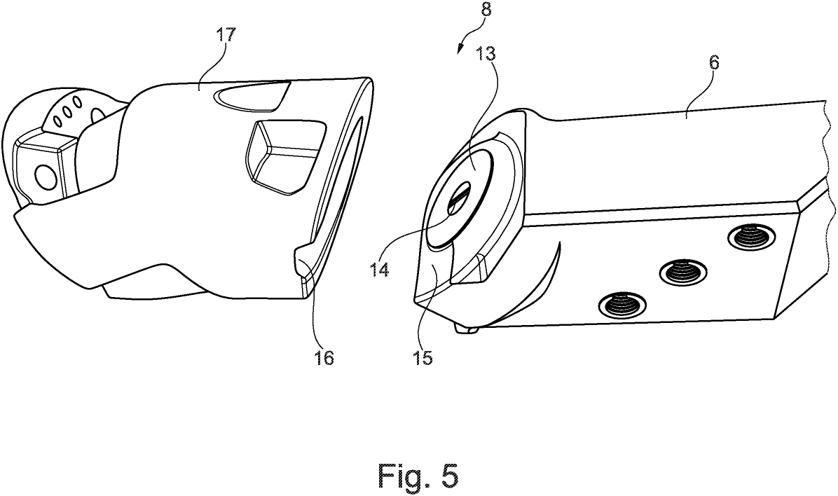

FIG. 5 is an enlarged view of the magnetic coupling of the lubricating tool from FIG. 2.

FIG. 1 schematically shows an IS machine 1 for producing glass containers according to a preferred exemplary embodiment of the invention. The IS machine 1 is provided with a plurality of stations 2, which each comprise a blank mold 3 and a finishing mold 4. For the sake of simplicity, FIG. 1 only shows three stations 2, and the remaining stations are indicated by dots.

In terms of providing uniform product quality that is constant over time, the surfaces of the blank molds 3 that come into direct contact with the molten glass require lubrication in order to ensure uniform distribution of the glass material within the mold cavity when said glass material is introduced into the relevant blank mold 3 and to make it easier to release the parison, which is still mechanically unstable, from the relevant blank mold 3 after shaping. To do this, the IS machine 1 comprises a lubricating tool 5 that can be manipulated by a robot 19 for lubricating the blank molds 3 with a lubricant. For this purpose, the lubricating tool 5 is provided with three spray heads 18 arranged on a spray head holder 6 for spraying the lubricant and with a robot connection 7, to which the spray head holder 6 is fastened and by means of which the lubricating tool is connected to the robot 19. As indicated in FIG. 1 by a horizontal double-headed arrow, the lubricating tool 5 is movable between different stations 2 together with its robot connection 7 and the spray heads 18 within the IS machine 1 by means of the robot 19, such that the blank molds 3 at different stations 2 can be lubricated in succession.

It is then essential for the spray heads 18 to be reversibly detachably fastened to the robot connection 7 by means of a coupling 8 in order to prevent any damage to the lubricating tool 5 or the robot 19 in the event of a collision with mechanisms at a station 2. A coupling 8 is therefore used which opens in the event of a collision such that the spray heads 18 are separated from the robot connection 7. Owing to this separation, no more force can be transmitted to the robot connection 7. The coupling 8 is designed such that the spray head holder 6 is reversibly detachable from the robot connection 7. The spray head holder 6 can therefore also be fastened to the robot connection 7 again via the coupling 8, namely by closing the coupling 8. The coupling 8 therefore does not sustain any damage when it is opened, and therefore it can be closed again without being repaired.

There are various options for those couplings which can be reversibly detachably fastened to the robot connection 7. One of those options is that the coupling 8 is a magnetic coupling. In this case, the magnetic force can be used to set the force that needs to be applied to the spray heads 18 to separate them from the robot connection 7. FIG. 2 shows those spray heads 18 which are fastened to the spray head holder 6 and are fastened to the robot connection 7 of the lubricating tool 5 via a coupling 8 designed as a magnetic coupling. FIG. 5 is an enlarged view of the coupling 8 designed as a magnetic coupling. This figure shows that the spray head holder 6 is provided at its end closest to the robot connection 7 with a magnet 13, which is fastened to the spray head holder 6 by a screw 14. This magnet 13 interacts with a magnet which is not visible in FIG. 5, but which is fastened in the same manner to a counterpart 17 arranged on the robot connection 7. In order to ensure that the spray head holder 6 is correctly oriented relative to the robot connection 7, the end region interacting with the counterpart 17 is provided with a rib 15, which engages in a groove 16 provided on the counterpart 17 when the coupling 8 is closed.

The spray head holder 6 is provided with a control air line, a lubricant line, and an atomizing air line, these lines all extending completely in the interior of the spray head holder 6, and therefore they are not visible in FIG. 2. These lines are each provided with a connection 10, shown in FIG. 2, adjacently to the coupling 8. During operation of the lubricating tool 5, a hose is attached to each of the connections 10 and is connected to the robot connection 7 at its other end in order to receive control air, lubricant, or atomizing air. To do this, connections 11 are also provided on the robot connection 7. For the sake of clarity, these hoses are not shown in FIG. 2. These hoses mean that, if the spray head holder 6 becomes detached from the robot connection 7, the spray head holder 6 does not fall into the station 2 at which the lubricating tool 5 is currently located, but instead is held by the hoses. The spray head holder 6 can then be manually fitted back onto the robot connection 7, and the station 2 can continue to be operated.

FIG. 3 shows an alternative configuration of the coupling 8. This figure shows that the coupling 8 is designed as a safety coupling comprising a mechanism which reversibly detaches the spray head holder 6 from the robot connection 7 when a force exceeding a predetermined force value is applied to the spray head holder 6.A safety coupling of this kind can be constructed in accordance with the ball-catch principle, for example: In this case, the spray head holder 6 is connected to the robot connection 7 in a form-fitting manner by means of balls or rollers. The coupling hub is designed as a ball cage and is used as a receptacle for a flange ring, an index plate comprising a disc spring, and an adjusting nut. The balls or rollers are pressed into countersunk holes in the flange ring at a set spring force. In the event of excessive loading, the flange ring rotates relative to the cage hub, the balls are pushed out of the spherical indentations, and the spray head holder 6 is separated from the robot connection 7. Moreover, the structure of the assembly shown in FIG. 3 corresponds to that shown in FIG. 2.

An essential point regarding the lubricating tools 5 described in the present case is that the lubricating tool 5 is provided with a sensor 12, by means of which it can be detected whether the coupling 8 is open or closed. This is shown schematically in FIG. 4, which is, inter alia, an enlarged view of the lubricating tool from FIG. 1. This sensor 12 can be designed as a capacitive sensor, for example. This sensor 12 is connected to a switch apparatus 9, also shown in FIG. 1, using which the operation of the station 2 at which the spray head holder 6 comprising the spray heads 18 is currently located can be terminated when it is established by the sensor 12 that the coupling 8 is open. This switch apparatus 9 is also designed and configured such that the operation of the station 2 at which the spray head holder 6 comprising the spray heads 18 is currently located is permitted again when it is established by the sensor 12 that the coupling 8 is closed again, e.g. by the spray head holder 6 having been manually fitted back onto the robot connection 7. In this case, however, the station 2 is not put back into operation automatically, but only after this is approved by a user.

This makes the following method for operating the IS machine 1 possible:

For lubricating the blank molds 3 at the stations 2, the spray heads 18 are moved back and forth between the different stations 2 within the IS machine 1. In the process, it is detected whether the coupling 8 is closed or open. If the spray head holder 6 then becomes detached from the robot connection 7 due to a spray head 18 colliding with a mechanism of a station 2, this is detected by the sensor 12. If this happens, the operation of the station 2 at which the lubricating tool 5 is currently located is automatically terminated. This can ensure that no further damage is sustained by the IS machine 1 or the robot 19 due to the spray head holder 6 becoming detached. A message is output, e.g. by the robot 19, and the spray head holder 6 can be manually fitted back onto the robot connection 7.

List of reference signs

| | |
|---|---|
| 1 | IS machine |
| 2 | Stations |
| 3 | Blank mold |
| 4 | Finishing mold |
| 5 | Lubricating tool |
| 6 | Spray head holder |
| 7 | Robot connection |
| 8 | Coupling |
| 9 | Switch apparatus |
| 10 | Connections to the spray head holder |
| 11 | Connections to the robot connection |
| 12 | Sensor |
| 13 | Magnet |
| 14 | Screw |
| 15 | Rib |
| 16 | Groove |
| 17 | Counterpart |
| 18 | Spray heads |
| 19 | Robot |

1. An IS machine for producing glass containers, comprising a plurality of stations which each comprise a blank mold and a finishing mold, and comprising a lubricating tool for lubricating at least some of the blank molds with a lubricant, the lubricating tool comprising a spray head for spraying the lubricant and comprising a robot connection, to which the spray head is fastened and by means of which the spray head is movable between different stations within the IS machine, the spray head being reversibly detachably fastened to the robot connection by means of a coupling, wherein
the robot connection is provided with a sensor, by means of which it can be detected whether the coupling is open or closed, and
the sensor is connected to a switch apparatus, using which the operation of the station at which the spray head is currently located can be terminated, and/or by means of which a robot action can be initiated when it is established by the sensor that the coupling is open.

2. The IS machine according to claim 1, wherein the coupling is a magnetic coupling.

3. The IS machine according to claim 1, wherein the coupling is a safety coupling comprising a mechanism which reversibly detaches the spray head from the robot connection when a force exceeding a predetermined force value is applied to the spray head.

4. The IS machine according to claim 1, wherein the switch apparatus is designed and configured such that the operation of the station at which the spray head is currently located is permitted again when it is established by the sensor that the coupling is closed again.

5. The IS machine according to claim 1, wherein the robot connection is provided with a control air line, a lubricant line, and an atomizing air line, and at least one of these lines extends at least partly in the interior of a spray head holder to which the spray head is fastened.

6. The IS machine according to claim 5, the control air line, the lubricant line, and the atomizing air line all extend completely in the interior of the spray head holder and are each provided with a connection adjacently to the coupling, and a hose is attached to each of the connections and is connected to a relevant connection of the robot connection at its other end in order to supply the spray head with control air, lubricant, or atomizing air.

7. A method for operating an IS machine for producing glass containers, wherein the IS machine comprises a plurality of stations which each comprise a blank mold and a finishing mold, and comprises a lubricating tool for lubricating at least some of the blank molds with a lubricant, the lubricating tool comprising a spray head for spraying the lubricant and comprising a robot connection, to which the spray head is fastened, the spray head being reversibly detachably fastened to the robot connection by means of a coupling, the method comprising:
moving the spray head between different stations within the IS machine and lubricating a relevant blank mold,
detecting whether the coupling is closed or open, and
terminating the operation of the station at which the spray head is currently located and/or initiating a robot action when it is established that the coupling is open.
